(19) United States
(12) Patent Application Publication
(10) Pub. No.: US 2004/0182988 A1
(43) Pub. Date: Sep. 23, 2004

(54) Low height concrete products mold for Besser style molds

(76) Inventor: Michael James Wardell, Puyallup, WA (US)

Correspondence Address: C & W Enterprises, 2316 12th Pl. S.E., Puyallup, WA, 98374, US

(21) Appl. No.: 10/388,556

(22) Filed: Mar. 17, 2003

(51) Int. Cl. B28B 7/00

(52) U.S. Cl. 249/122

(57) ABSTRACT

What is new is, a mold designed to eliminate the problems of bending metal pallets, pallet jams, lost product and production associated with a pallet not being placed or positioned squarely or centered under a mold during the pallet delivery sequence of a machine cycle.

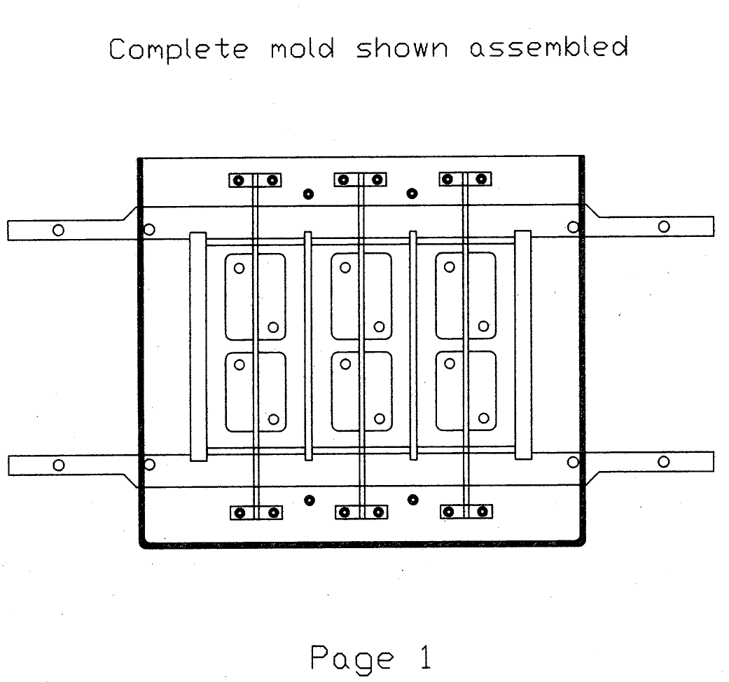

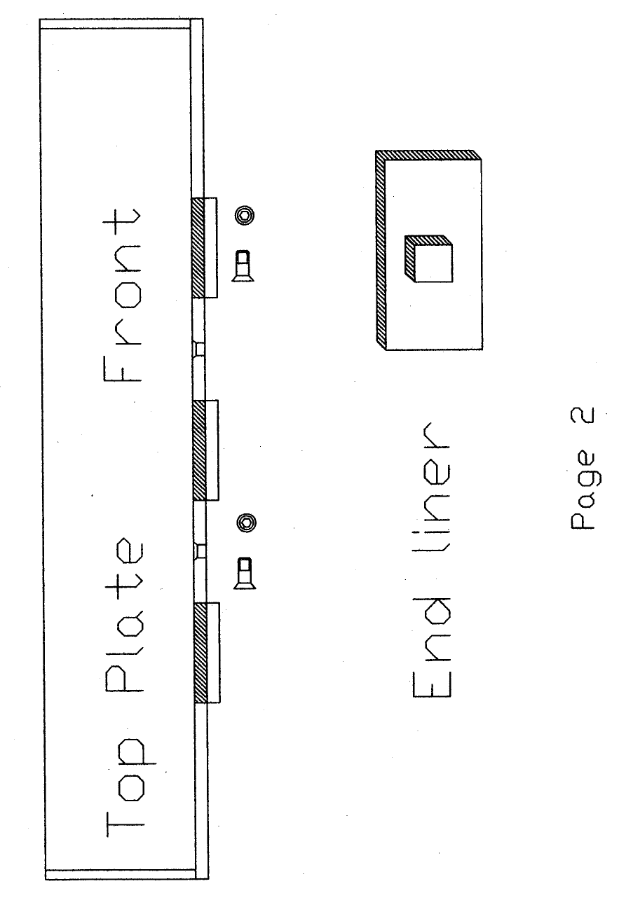

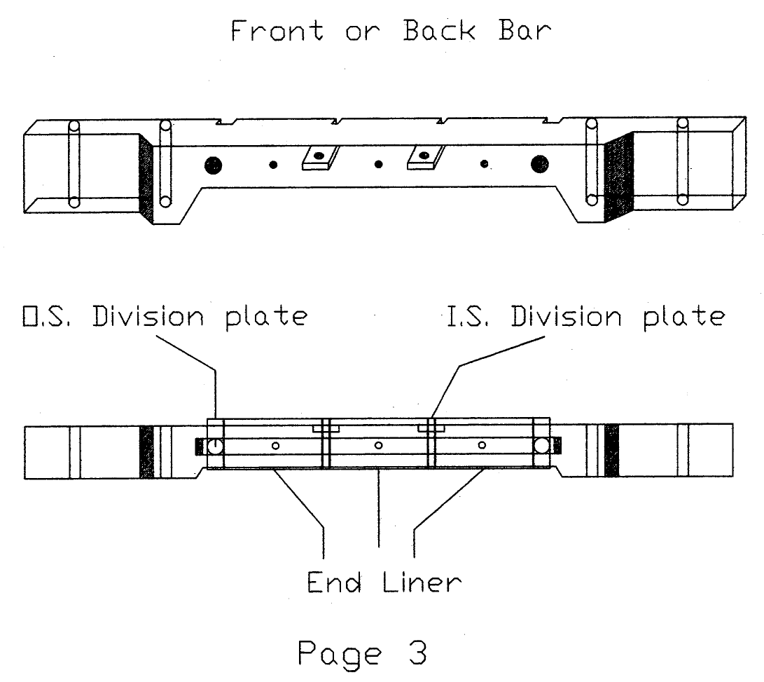

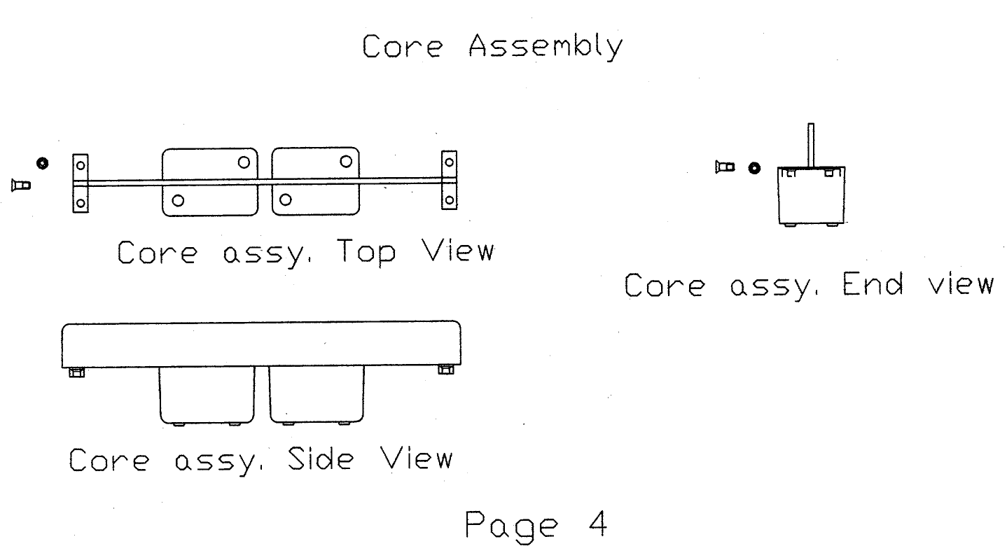

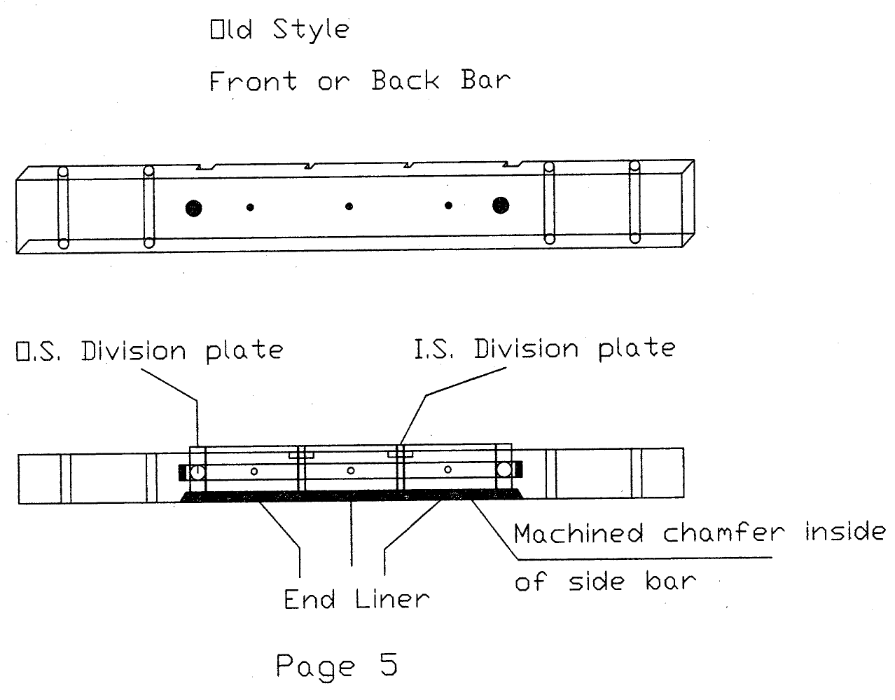

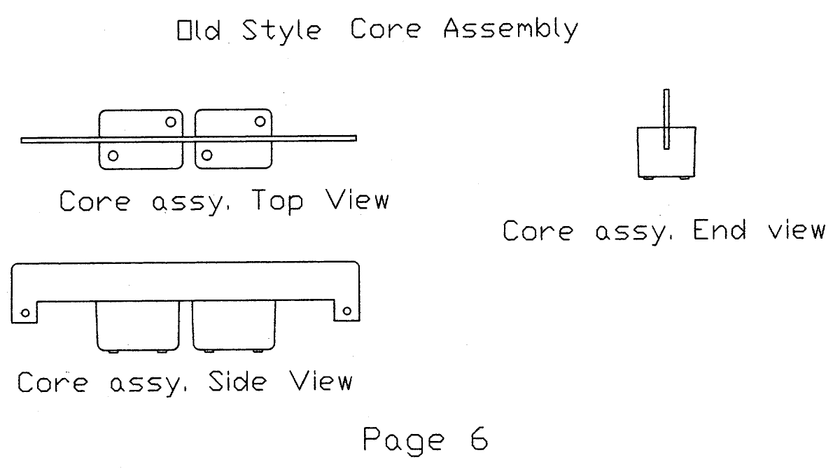

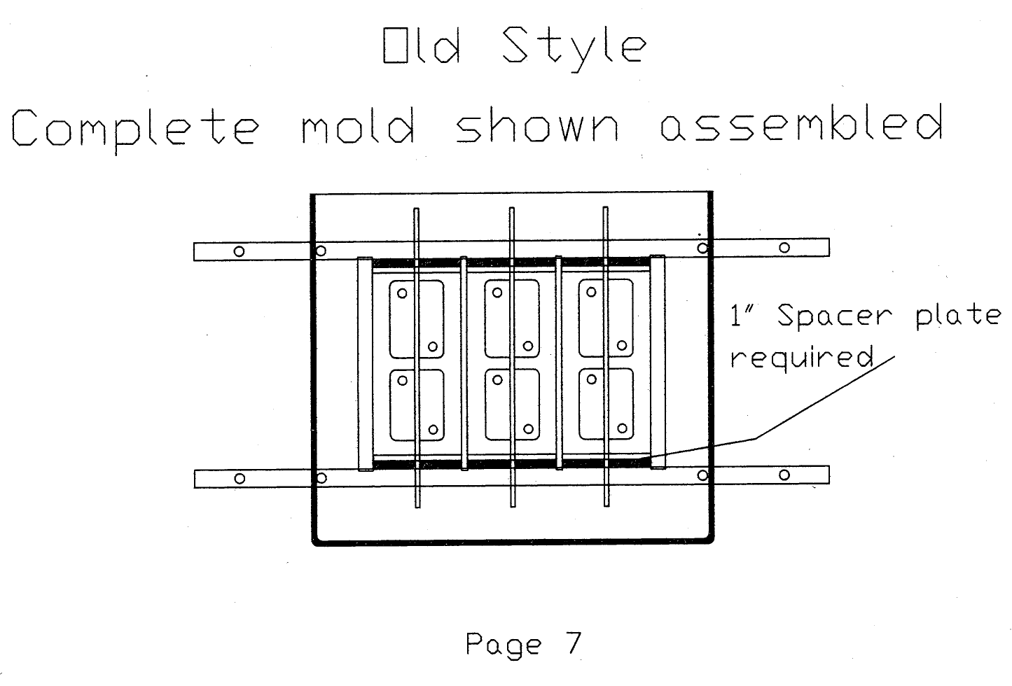

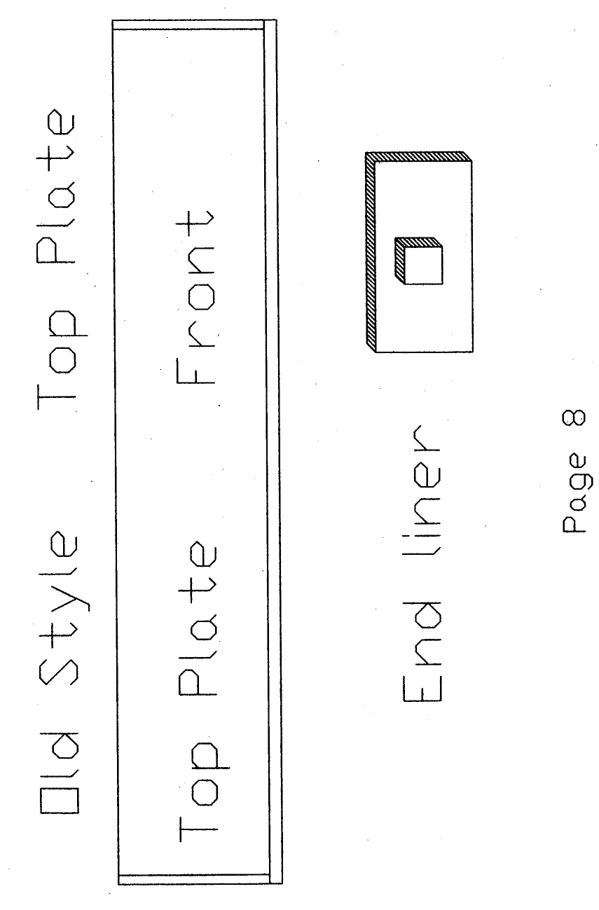

### CROSS REFERENCE TO RELATED APPLICATIONS

None

### COPYRIGHT STATEMENT

Not applicable

### FEDERAL RESEARCH STATEMENT

Not applicable

### APPENDIX DATA

Not applicable

### BACKGROUND OF INVENTION

The background in the manufacture of concrete products. This mold is designed to eliminate the problem with existing Besser style low height concrete molds when a metal pallet is positioned under the mold. Currently if a metal pallet coming into position under a Besser style low height mold is crooked or skewed it will hit guides or chamfers that are machined in the mold frame front and back bars causing the pallet to jamb and bend. When the pallet jambs or bends it causes the loss of the product, the pallet and more often than not the machine operator has to shut down production to clear the jamb meaning more loss of production.

### SUMMARY OF INVENTION

This new design to the molds eliminates the machined guides or chamfers to the mold front and back bars. Historically low height mold front and back bars are 6″ high and 1½″ thick with a ½″ piece of flat steel welded along the face of the front and back bars. The welded ½″ bar is dual purpose, first to act as a stiffener, the second as a way of attaching the mold cores assemblies to the mold. They are also machined with a chamfer on the inside of the front and back bars, this chamfer is there to help keep the strength of the bar and the height is there to allow enough room for the ½″ stiffener to be welded in a position so the core hold downs can be attached. This new design eliminates the machined chamfer on the inside of the bars thus eliminateing the risk of improper positioned pallets hitting the chamfer and causing damaged pallets and lost product. It also eliminates the need of the welded bar as a way of attaching the cores to the mold.

A low height concrete product is any concrete product under 5⅝″ high. Many different styles, configurations and quantities of product can be made in a low height mold. Including but not limited to standard precision (nominal dimensions) 2″, 4″, 6″, 8″, 10″, 12″ and retaining wall block (SRW). When low height product mold is used the pallet has to be placed precisely up inside the chamfered bars so it will make contact with the bottom of the division plates and end liners, these division plates and end liners are what determines the dimensions and separate the product being manufactured in the mold. The division plates and end liners are wear parts and replaced when they wear to the point the product dimensions are no longer within specification. The core assemblies are used to create the void in the concrete product, these are also wearing items.

This new design mold frame uses thicker front and back bars that are 2½″ thick and 4¾″ high where the end liners are inserted. This allows the division plates and end liners to protrude ⅛″ below the front and back bars and 3″ above the bars. By having the end liners and division plates protrude below the bars it insures uniform contact with these pallets with out having to travel up between the chamfered front and back bars. Thus allowing a pallet that not precisely positioned to still be usable without risk of damage to the pallet and loss of product.

The other change to the mold is how the core assemblies are attached. Historically the core assembly has a fin or tang on each end that protrudes through slots in the mold top plate. This fin or tang has a hole in it that allows it to be attached to a hold down block that is in turn bolted to the ½″ bar that is welded to the front and back bars. The change is, the fin is cut even with the mold top plate and a piece of flat steel is welded perpendicular to the core assembly bar. This flat steel has two holes in it to allow it to be bolted directly to the top plate, eliminating the need for the hold down blocks. The other advantage to attaching the core assemblies this way is to eliminate the risk of the cores being skewed sideways.

### BRIEF DESCRIPTION OF DRAWINGS

These drawings show the several individual parts, which would go into the make up of a mold.

Drawing 1. Complete top view of mold showing 3 8×8×16 (nominal dimension)

Drawing 2. Front view of a mold top plate/end liner

Drawing 3. Front view and isometric view of a thicker front or back bar machined up only in the middle, eliminateing the chamfer to the inside

Drawing 4. Core assembly, top, side and end view

Drawing 5. Old style, front and isometric view showing the chamfer machined on the inside

Drawing 6. Old style core assembly

Drawing 7. Old style complete mold assembly, 1″ spacer required to space out front and back bars

Drawing 8. Old style mold top plate and end liner

### BRIEF DESCRIPTION OF SEQUENCES

Not applicable

### DETAILED DESCRIPTION

In the manufacture of all concrete masonry units whether it be on a Besser, Columbia, Steams, Omag, Hess, Reikers, Flemming, Zenith, Masa, Knuar, Tiger or any other manufacturer of concrete products machines, some of which are called block machines, some are called paver machines, the sequence of operation and concept of manufacture is the same. The products are made in a mold; the size and configuration will vary depending on the product being produced. There are hundreds of different products and variations on each product. There can be a variation of the materials used in the manufacture of the concrete products, this variation is because of the type of product being manufactured and the availability of aggregates in the area, however all use a combination of cement, sand/gravel/cinders, etc. what ever is available and water to mix the combinations into a semi-dry mix. There may also be some admix or color added to the mix. The sequence of operation is:

1. A mold is placed in the machine

2. A pallet, either metal or wood is positioned under and tight against the bottom of the mold

3. The machine cycles to a point where a feedbox is positioned over the mold

4. Concrete material is dropped or vibrated from the feedbox into the mold after filling the mold the feedbox is reversed

5. A head, comes down containing shoes, is pressed and vibrated into the mold to compact the materials into the mold

6. After a time or setting is reached the machine cycles to a position to strip or push the compacted product from the mold

7. This product is still uncured but solid enough to stay together in it's molded shape. The product is left on a pallet until it is cured enough to be handled

8. After the product is cured enough to be handled it is removed from the pallet and the cycle starts over again

The amount of cycles a machine can make in a day varies from machine to machine and the type of product being manufactured.

What I claim as my invention is:

1. A new mold design that eliminates the inside chamfering on the front and back bars on a low height product “Besser” style mold. This new style mold also requires the modification to how the core assemblies are attached to the mold, and a modification to the mold top plate to allow the cores to be attached directly to the top plate.
